(19) United States
(12) Patent Application Publication
(10) Pub. No.: US 2011/0239452 A1
(43) Pub. Date: Oct. 6, 2011

(54) Auto-removing assembly for a wire electric discharge machine

(75) Inventor: Shih-Tao Yang, Taichung (TW)

(73) Assignee: TAIWAN WIRECUT TECHNOLOGIES CO., LTD.

(21) Appl. No.: 12/798,141

(22) Filed: Mar. 30, 2010

(51) Int. Cl. B23P 19/00

(52) U.S. Cl. 29/762

(57) ABSTRACT

An auto-removing assembly is used for a wire electric discharge machine having an upper positioning head, a lower positioning head and a metal wire and has a blowing device, a suction device, a tension device, a fuse device and a transporting pipe. The blowing device is set near a front side of the metal wire and has a first guiding block and a first air source. The suction device is set near a rear side of the metal wire and has a second guiding block and a second air source. The tension device is set between the blow and suction devices. The fuse device is set near a left side of the metal Wire and has a pressure pump and a fused head. The transporting pipe is set above the suction device and aligns with the suction device to receive the fused metal wire.

### BACKGROUND OF THE INVENTION

1. Field of the Invention

The present invention relates to an auto-removing assembly, and more particularly to an auto-removing assembly for a wire electric discharge machine that can remove metal wires accurately.

2. Description of Related Art

With reference to FIG. 4, a conventional wire electric discharge machine is used to cut a metal work piece (F) and comprises an upper positioning head (A), a lower positioning head (B), a wire outlet device (C), a wire collecting device (D) and a metal wire (E). The upper positioning head (A) and the lower positioning head (B) are respectively set on an upper side and a lower side of a metal work piece (F). The wire outlet device (C) is set over the upper positioning head (A). The wire collecting device (D) is set under the lower positioning head (B). The metal wire (E) is pulled out from the wire outlet device (C), passes through the positioning heads (A, B) and is rolled up by the wire collecting device (D). The metal wire (E) is tautly stretched between the positioning heads (A, B) by the wire outlet device (C) and the wire collecting device (D) to cut the metal work piece (F).

When the metal wire (E) is broken between the positioning heads (A, B), a conventional auto-removing assembly can be used to remove the metal wire (E) and comprises a guiding mount (I), a tension device (J), a pushing block (K), an electrode device (L) and a transporting tube (M). The guiding mount (I) is set between the wire outlet device (C) and the upper positioning head (A) and has a bottom, a jet channel (I1) and a suction channel (I2). The jet channel (I1) is longitudinally formed through the guiding mount (I) and communicates with an air source near the bottom of the guiding mount (I). The suction channel (I2) is conical, is formed in the guiding mount (I) and communicates with the jet channel (I1). The tension device (J) is set below the guiding mount (I) beside the metal wire (E) and has two rolling wheels (J1). The rolling wheels (J1) are contacted with each other to press and clamp the metal wire (E) and are rotated in the opposite direction. The pushing block (K) is movably set near the guiding mount (I). The electrode device (L) is contacted with the metal wire (E) beside the pushing block (K) to fuse the metal wire (E) and has a positive electrode and a negative electrode. The transporting pipe (M) is set above the guiding mount (I) and communicates with the jet channel (I1) to collect the fused metal wire (E) between the pushing block (K) and the upper positioning head (A).

In operation, when the metal wire (40) is broken between the positioning heads (A, B), the electrode device (L) will fuse the metal wire (E) near the positive electrode and the pushing block (K) will push the fused metal wire (E) moving into the suction channel (I2) of the guiding mount (I). When the fused metal wire (E) is pushed into the suction channel (I2), the air source that connected to the jet channel (I1) will provide a suction force to the fused metal wire (E). Then, the fused metal wire (E) can be removed to the transporting pipe (M). However, when the metal wire (E) is fused by the electrode device (L) near the pushing block (K), the tautly tension of metal wire (E) will disappear and the position of one end of the fused metal wire (E) near the positive electrode can not be controlled easily. Then, the fused metal wire (E) can not be accurately pushed into the suction channel (I2) of the guiding mount (I) by the pushing block (K). In addition, the suction force provided by the air source may not be strong enough to suck the fused metal wire (E) into the transporting pipe (M).

To overcome the shortcomings, the present invention tends to provide an auto-removing assembly for a wire electric discharge machine to mitigate the aforementioned problems.

### SUMMARY OF THE INVENTION

The main objective of the present invention is to provide an auto-removing assembly for a wire electric discharge machine that can remove metal wires accurately.

The auto-removing assembly in accordance with the present invention is used for a wire electric discharge machine having an upper positioning head, a lower positioning head, a wire outlet device and a metal wire, and the auto-removing assembly has a blowing device, a suction device, a tension device, a fuse device, a transporting pipe and a detecting device. The blowing device is set near a front side of the metal wire and has a first guiding block and a first air source. The suction device is set near a rear side of the metal wire above the upper positioning head and has a second guiding block and a second air source. The tension device is set between the blowing device, the suction device and the upper positioning head and has a motor and two rolling wheels. The fuse device is set above the blowing device near a left side of the metal wire and has a pressure pump and a fused head. The transporting pipe is set above the suction device and aligns with the suction device to receive the fused metal wire.

Other objectives, advantages and novel features of the invention will become more apparent from the following detailed description when taken in conjunction with the accompanying drawings.

### BRIEF DESCRIPTION OF THE DRAWINGS

FIG. 1 is a front view of an auto-removing assembly for a wire electric discharge machine in accordance with the present invention;

FIG. 2 is a side view in partial section of the auto-removing assembly in FIG. 1;

FIG. 3 is an operational side view of the auto-removing assembly in FIG. 2; and

FIG. 4 is an operational side view in partial section of a conventional auto-removing assembly for a wire electric discharge machine in accordance with the prior art.

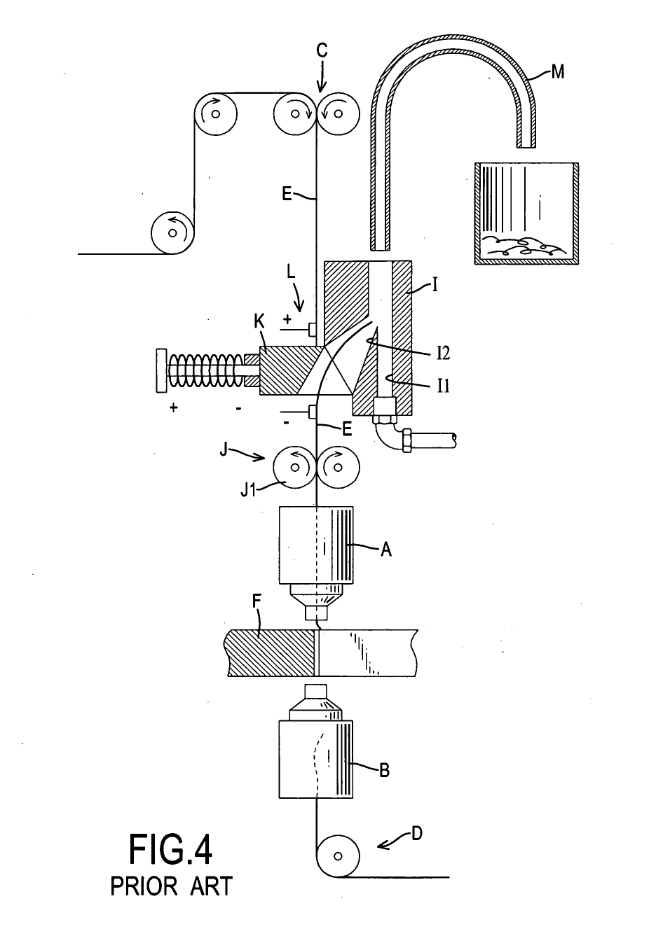

### DETAILED DESCRIPTION OF THE PREFERRED EMBODIMENT

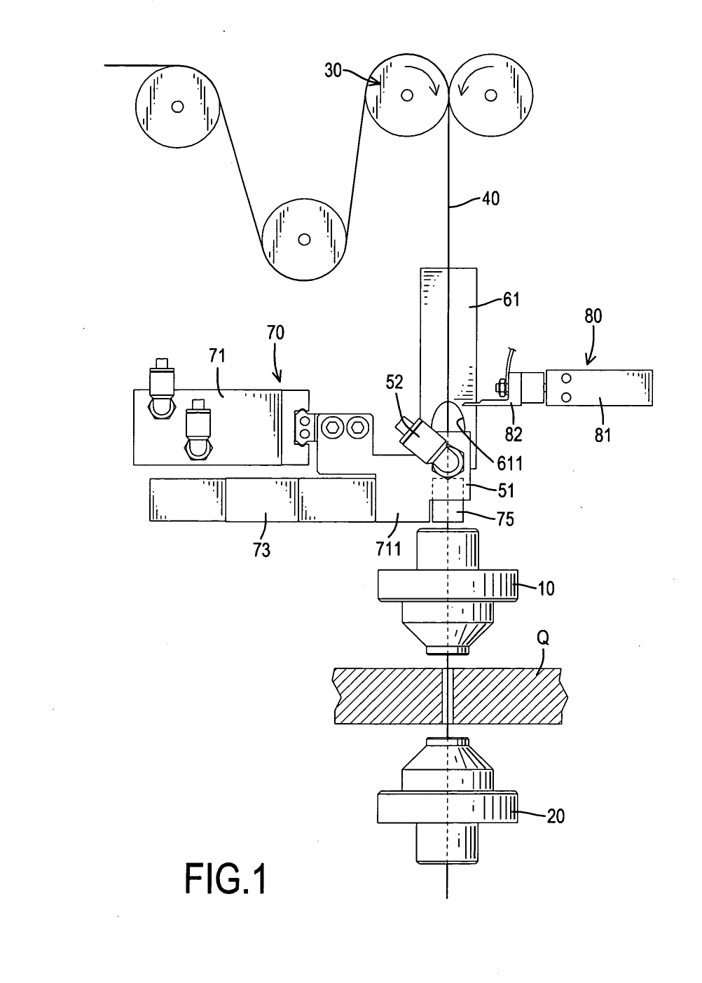

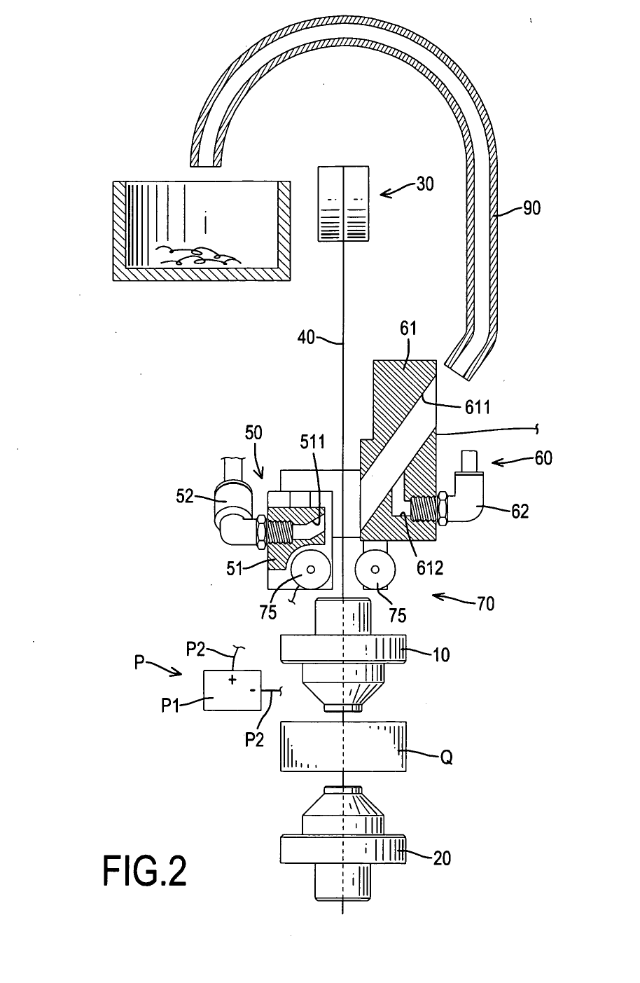

With reference to FIGS. 1 and 2, an auto-removing assembly in accordance with the present invention is mounted on a wire electric discharge machine having an upper positioning head (10), a lower positioning head (20), a wire outlet device (30), a metal wire (40) and a metal work piece (Q), and the auto-removing assembly is mounted on the wire electric discharge machine and comprises a blowing device (50), a suction device (60), a tension device (70), a fuse device (80), a transporting pipe (90) and a detecting device (P).

The upper positioning head (10) and the lower positioning head (20) are respectively set on an upper side and a lower side of a metal work piece (Q). The wire outlet device (30) is set over the upper positioning head (10). The metal wire (40) is pulled out from the wire outlet device (30), passes through the positioning heads (A, B) to cut the metal work piece (Q) and has a front side, a rear side, a left side and a right side.

With reference to FIGS. 1 and 2, the blowing device (50) is set near the front side of the metal wire (40) above the upper positioning head (10) and has a first guiding block (51) and a first air source (52). The first guiding block (51) is set near the front side of the metal wire (40) above the upper positioning head (10) and has a blow channel (511). The blow channel (511) is formed through the first guiding block (51) and has a blow end and a connecting end. The blow end of the blow channel (511) faces the front side of the metal wire (40). The first air source (52) is screwed with the first guiding block (51) and communicates with the connecting end of the blow channel (511).

The suction device (60) is set near the rear side of the metal wire (40) above the upper positioning head (10) and has a second guiding block (61) and a second air source (62). The second guiding block (61) may be made of metal, is set near the rear side of the metal wire (40) above the upper positioning head (10) and has a suction channel (611) and a jet channel (612). The suction channel (611) is obliquely formed through the second guiding block (61), aligns with the blow channel (511) of the first guiding block (51) and has a suction end and an outlet end. The suction end of the suction channel (611) faces the rear side of the metal wire (40) and aligns with the blow end of the blow channel (511) of the first guiding block (51). The jet channel (612) is formed in the second guiding block (61), communicates with the suction channel (611) and has a communicating end and a mounting end. The communicating end of the jet channel (612) communicates with the suction channel (611). The second air source (62) is screwed with the second guiding block (61) and communicates with the mounting end of the jet channel (612).

The tension device (70) is set between the blowing device (50), the suction device (60) and the upper positioning head (10) and has a driving cylinder (71), a motor (73) and two rolling wheels (75). The driving cylinder (71) is set near the right side of the metal wire (40) between the wire outlet device (30) and the upper positioning head (10) and has two clamping arms (711). The clamping arms (711) are respectively set on the front side and the rear side of the metal wire (40) and each clamping arm (711) is moved toward the metal wire (40) by the driving cylinder (71). In addition, the clamping arm (711) that set on the front side of the metal wire (40) is securely mounted on the first guiding block (51). Then, the first guiding block (51) can be moved toward the second guiding block by the corresponding clamping arm (711). The motor (73) is securely mounted on the clamping arm (711) that is mounted on the first guiding block (51) below the driving cylinder (71). The rolling wheels (75) may be made of metal, one of the rolling wheels (75) is rotatably connected to the motor (73) on the front side of the metal wire (40) and the other rolling wheel (75) is mounted on the clamping arm (711) that set on the rear side of the metal wire (40).

The fuse device (80) is set above the blowing device (50) near the left side of the metal wire (40) and has a pressure pump (81) and a fused head (82). The pressure pump (81) is set parallel to the metal work piece (Q) and has a free end toward the left side of the metal wire (40). The fused head (82) is mounted on the free end of the pressure pump (81) to fuse the metal wire (40) between the blowing device (50) and the suction device (60).

The transporting pipe (90) may be U-shaped, is set above the suction device (60) and has an inlet aligning with the of the outlet end of the suction channel (611) of the second guiding block (61) to receive the fused metal wire (40).

The detecting device (P) is an open circuit normally, is set near the tension device (70) and is electrically connected to the motor (73) of the tension device (70) and has a power supply (P1) and two electric cords (P2). One of the electric cords (P2) is electrically connected to the power supply (P1) and the rolling wheel (75) that mounted on the first guiding block (51) and the other electric cord (P2) is electrically connected to the power supply (P1) and the second guiding block (61). When the rolling wheels (75) clamp the metal wire (40) by the driving cylinder (71) and the fused metal wire (40) contacts the inner wall of the second guiding block (61), the detecting device (P) can be a closed circuit and this can be used to determine location of the fused metal wire (40).

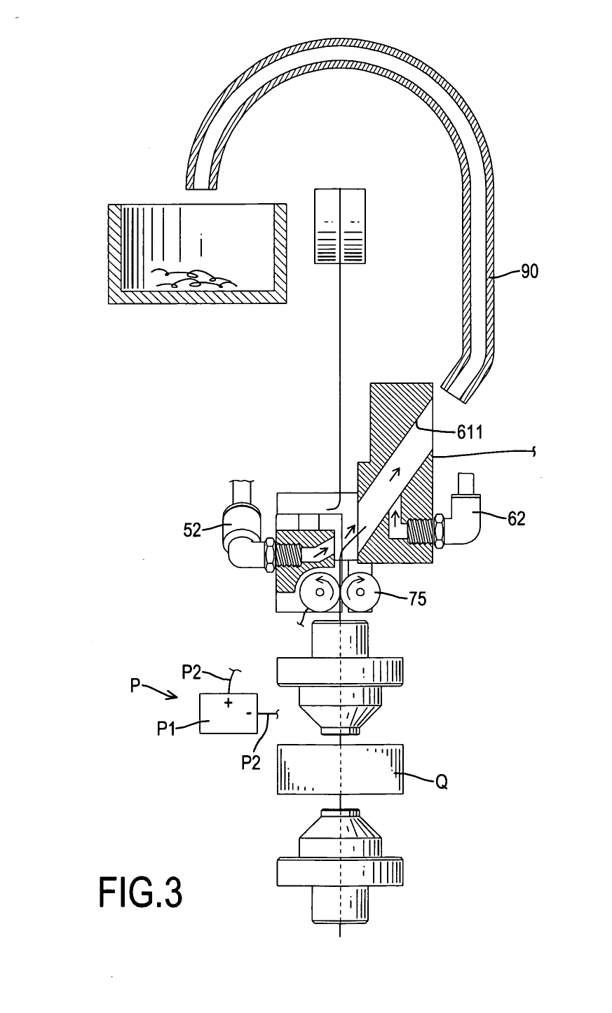

With reference to FIG. 3, when the metal wire (40) is broken during cutting a metal work piece (Q) between the positioning heads (10, 20), the rolling wheels (75) will move toward and clamp the metal wire (40) between the blowing device (50), the suction device (60) and the upper positioning head (10) when the clamping arms (711) are driven by the driving cylinder (71). At the same time, the blowing device (50) on the corresponding clamping arm (711) will move toward the suction device (60) by the driving cylinder (71). After the rolling wheels (75) clamp the metal wire (40), the second air source (62) will provide a stable suction airflow in the suction channel (611) of the second guiding block (61) and the first air source (52) will provide a blown airflow to the suction channel (611) via the blow channel (511). Then, a sufficient traction force is provided between the blowing device (50) and the suction device (60) to suck the metal wire (40) into the suction channel (611).

With further reference to FIGS. 1 and 3, when the traction force is provided between the blowing device (50) and the suction device (60), the fused head (82) is moved toward to fuse and cut the metal wire (40) near the suction channel (611) of the second guiding block (61) by the pressure pump (81). When the metal wire (40) is cut by the fused head (82), one end of the fused metal wire (40) will be attracted into the suction channel (611) of the second guiding block (61) by the traction force. As the end of the fused metal wire (40) is attracted by the traction force to contact the second guiding block (61) in the suction channel (611), the detecting device (P) will become a closed circuit and the rolling wheels (75) will be rotated by the motor (73) to move the fused metal wire (40) upward into the suction channel (611) of the second guiding block (61). Then, the fused metal wire (40) will be moved by the rotation force of the rolling wheels (75) and the traction force of the blowing device (50) and the suction device (60) will make the broken and fused metal wire (40) accurately removing into a store box via the transporting pipe (90). Furthermore, when the broken and fused metal wire (40) has been removed in the store box, the detecting device (P) will return to an open circuit and the rolling wheels (75) will stop rotating.

The auto-removing assembly as described for a wire electric discharge machine has the following advantages.

1. When the metal wire (40) is fused and cut by the fuse device (80), the end of fused metal wire (40) can be attracted into the suction channel (611) of the second guiding block (61) by the traction force without moving the fused metal wire (40) by the pushing block (K).

2. When the metal wire (40) is broken during cutting a metal work piece (Q) between the positioning heads (10, 20), the blowing device (50) and the suction device (60) will respectively provide a blown airflow and a suction airflow to form a sufficient traction force for the metal wire (40), and this can hold and control the fused metal wire (40) at a correct position in the suction channel (611) of the second guiding block (61).

3. The detecting device (P) can become a closed circuit or an open circuit to determine the broken and fused metal wire (40) in the suction channel (611) or not to let the rolling wheels (75) rotating relative to the clamping arms (711) to move the broken and fused metal wire (40).

4. In the present invention, the fused metal wire (40) will be moved by the rotation force of the rolling wheels (75) and the traction force of the blowing device (50) and the suction device (60) will make the broken and fused metal wire (40) accurately remove into a store box via the transporting pipe (90).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An auto-removing assembly for a wire electric discharge machine having an upper positioning head, a lower positioning head, a wire outlet device over the upper positioning head and a metal wire pulled out from the wire outlet device and passed through the positioning heads to cut a metal work piece with a front side, a rear side, a left side and a right side, and the auto-removing assembly comprising
a blowing device adapted to set near the front side of the metal wire above the upper positioning head and having
a first guiding block adapted to set near the front side of the metal wire above the upper positioning head and having
a blow channel formed through the first guiding block and having
a blow end facing the front side of the metal wire; and
a connecting end; and
a first air source mounted on the first guiding block and communicating with the connecting end of the blow channel;
a suction device adapted to set near the rear side of the metal wire above the upper positioning head and having
a second guiding block adapted to set near the rear side of the metal wire above the upper positioning head and having
a suction channel obliquely formed through the second guiding block, aligning with the blow channel of the first guiding block and having
a suction end facing the rear side of the metal wire and aligning with the blow end of the blow channel of the first guiding block; and
an outlet end; and
a jet channel formed in the second guiding block, communicating with the suction channel and having
a communicating end communicating with the suction channel; and
a mounting end; and
a second air source mounted on the second guiding block and communicating with the mounting end of the jet channel;
a tension device adapted to set between the blowing device, the suction device and the upper positioning head and having
a motor adapted to set near the right side of the metal wire between the wire outlet device and the upper positioning head; and
two rolling wheels, one of the rolling wheels rotatably connected to the motor on the front side of the metal wire and the other rolling wheel adapted to set on the rear side of the metal wire, the rolling wheels moved toward to and clamped the metal wire;
a fuse device set above the blowing device near the left side of the metal wire and having
a pressure pump adapted to set parallel to the metal work piece and having a free end toward the left side of the metal wire; and
a fused head mounted on the free end of the pressure pump to fuse the metal wire between the blowing device and the suction device; and
a transporting pipe set above the suction device and having an inlet aligning with the of the outlet end of the suction channel of the second guiding block to receive the fused metal wire.

2. The auto-removing assembly as claimed in claim 1, wherein
the second guiding block and the rolling wheels are made of metal; and
the auto-removing assembly has a detecting device being an open circuit, set near the tension device and electrically connected to the motor of the tension device and having
a power supply; and
two electric cords, one of the electric cords electrically connected to the power supply and one of the rolling wheels and the other electric cord electrically connected to the power supply and the second guiding block.

3. The auto-removing assembly as claimed in claim 2, wherein
the tension device has a driving cylinder adapted to set near the right side of the metal wire between the wire outlet device and the upper positioning head and having two clamping arms respectively set on the front side and the rear side of the metal wire and each clamping arm moved toward the metal wire by the driving cylinder, and the clamping arm that set on the front side of the metal wire securely mounted on the first guiding block;
the motor is securely mounted on the clamping arm that mounted on the first guiding block below the driving cylinder; and
the rolling wheel that set on the rear side of the metal wire is mounted on the clamping arm.

4. The auto-removing assembly as claimed in claim 1, wherein
the tension device has a driving cylinder adapted to set near the right side of the metal wire between the wire outlet device and the upper positioning head and having two clamping arms respectively set on the front side and the rear side of the metal wire and each clamping arm moved toward the metal wire by the driving cylinder, and the clamping arm that set on the front side of the metal wire securely mounted on the first guiding block;
the motor is securely mounted on the clamping arm that mounted on the first guiding block below the driving cylinder; and
the rolling wheel that set on the rear side of the metal wire is mounted on the clamping arm.
